(19) United States
(12) Patent Application Publication
(10) Pub. No.: US 2020/0352184 A1
(43) Pub. Date: Nov. 12, 2020

(54) Prevention of Postharvest Physiological Deterioration using Sulfur-Donating Compounds

(71) Applicant: Apeel Technology, Inc., Goleta, CA (US)

(72) Inventors: Charles Patrick Frazier, Goleta, CA (US); Stephen William Kaun, Goleta, CA (US); Chance Holland, Santa Barbara, CA (US)

(21) Appl. No.: 16/639,527

(22) PCT Filed: Aug. 17, 2018
(86) PCT No.: PCT/US2018/046994

§ 371 Date: Feb. 14, 2020

Related U.S. Application Data
(60) Provisional application No. 62/546,652, filed on Aug. 17, 2017.

(51) Int. Cl. A23B 7/157; A23B 7/10

(52) U.S. Cl. CPC A23B 7/157; A23B 7/10

(57) ABSTRACT

The present disclosure is directed to the prevention of spoilage of agricultural products (e.g., tuberous roots such as cassava roots). The disclosure teaches the use of a sulfur-donating compound (e.g., a thiosulfate salt such as sodium thiosulfate) to enable the agricultural product to scavenge endogenously-produced HCN, prevent the buildup of reactive oxygen species, prevent the buildup of insoluble byproducts, and/or prevent the loss of starch from the agricultural product.

### TECHNICAL FIELD

Compositions for the prevention of spoilage of agricultural products and methods of making and using thereof are described herein.

### BACKGROUND

Cassava is one of the staple crops in many parts of Africa and South America. Worldwide, about 800 million people currently depend on cassava as their primary food staple. It is one of the most drought-tolerant crops, capable of being grown in marginal soils, and can give reasonable yields in places where many other crops do not grow as well. Cassava is a long, tapered root with a whitish or yellowish flesh. It can be dried and ground to a powdery extract known as tapioca.

The liberation of endogenous compounds, such as hydrogen cyanide, during harvest and processing of some agricultural products such as cassava root is a product of the natural production of cyanogenic glycosides, such as linamarin, by the agricultural product (e.g., as a defense mechanism, or as a means of nitrogen transport). While linamarin can be natively non-toxic for the plant and localized in vacuoules, upon damage to the cassava, cellular rupture can release linamarase, an enzyme that can metabolize linamarin into glucose and acetone cyanohydrin, which can ultimately degrade to acetone and hydrogen cyanide, or salts thereof, through an enzymatic or spontaneous reaction, as set forth below in Scheme 1.

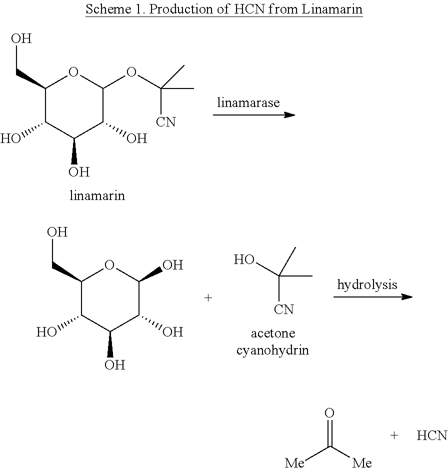

Hydrogen cyanide can contribute to the deterioration process in some agricultural products such as cassava by disrupting the interplay of proteins that drive cellular respiration, known as the mitochondrial electron transport chain. As shown in FIG. 1, HCN can competitively bind to Complex IV of the electron transport chain, can prevent the binding of oxygen that drives transmembrane proton transport, and can shut down ATP production. As further shown in FIG. 1, disruption to the mitochondrial transport chain by hydrogen cyanide can shut down ATP production by mitochondria (e.g., at Complex V). This can trigger upstream release of reactive oxygen species (e.g., at Complex I and/or Complex III), which in turn can lead to PPD. Upstream release of reactive oxygen species (ROS) from Complex I and Complex III can trigger cellular breakdown of the cassava. For example, this can be observed as the postharvest physiological deterioration (PPD) of the root.

While production of cassava is widespread throughout much of the developing world, postharvest preservation is a major problem. As described above, once harvested and separated from the main plant, cassava undergoes postharvest physiological deterioration (PPD) resulting from the liberation of cyanide during harvest. This process begins within minutes after the root is damaged and renders the tuberous root inedible and useless typically within two or three days. PPD is the primary obstacle currently preventing farmers from exporting cassava abroad and generating income from their crops. Postharvest treatments that specifically address cassava cyanide content, which has been found to be the key driver of spoilage in cassava, have to date been unsuccessful at addressing the problems associated with PPD described above.

There exists a need for pre- and/or post-harvest treatments, which reduce the degradation and/or deterioration (e.g., spoilage) of agricultural products, particularly those that liberate endogenous molecules which can increase the degree and/or rate of spoilage, such as cassava root. There also exists a need for pre- and/or post-harvest treatments which, when applied to a surface, react with endogenous compounds responsible for degrading or deteriorating the agricultural product, such as HCN, to reduce or minimize the degradation or deterioration.

### SUMMARY

Sulfur-donating compounds, and compositions containing the same, for the prevention of spoilage of agricultural products, and methods of making and using thereof, are described herein. In some embodiments, sulfur-donating compounds, or compositions containing the same, are applied to the surface of agricultural products, including cut surfaces, in order to reduce spoilage of the products. Specifically, application of a sulfur-donating compound can, for example, (1) enable the agricultural product to scavenge endogenously-produced molecules that cause degradation or deterioration of the agricultural product, such as HCN, (2) change the oxidation state of an enzyme (e.g., cysteine) or cofactor (e.g., metal) in order to (i) inhibit the mechanism of physiological deterioration of the agricultural product, (ii) inhibit production of an endogenous compound which can degrade, deteriorate, or spoil the product, or (iii) activate the enzyme or cofactor to react with an endogenous molecule to detoxify the endogenous molecule, (3) prevent the buildup of reactive oxygen species, (4) prevent the buildup of insoluble byproducts, (5) reduce discoloration of the agricultural product, and/or (6) prevent the loss of starch from the agricultural product. Methods of reducing spoilage that merely supplement the agricultural product's natural mechanism for preventing spoilage are also described.

The sulfur-donating compound can be an inexpensive sulfur-donating salt including, but not limited to, salts of dithionate, dithionite, metabisulfite (i.e. disulfite), tetrathionate, or thiosulfate. Many sulfur-donating compounds, such as salts of metabisulfite, and thiosulfate, are Generally Regarded as Safe (GRAS) food additives and thus are safe for human consumption. Furthermore, sulfur-donating salts of dithionate, dithionite, metabisulfite (i.e. disulfite), tetrathionate, and/or thiosulfate can be sufficiently stable enough to be stored easily for long periods and require no special equipment for storage. In some embodiments, the sulfur-donating compound can be applied as a dry powder, alone or in combination with one or more excipients and/or additional compounds. In other embodiments, the sulfur-donating compound can be formulated with one or more excipients and/or additional compounds as a solution, suspension, emulsion, or colloid. In some embodiments, the sulfur-donating compound or the composition containing the same is edible.

Application of compositions and methods described herein to agricultural products allow for a robust, low-cost method for reducing the spoilage of the agricultural products that does not rely on costly methods such as selective breeding, selective farming, storage, or toxic chemicals. The methods and compositions disclosed herein can effectively increase the shelf life of an agricultural product (e.g., a cassava root).

Any of the methods and compositions described herein can each include one or more of the following steps or features, either alone or in combination with one another. The physiological deterioration can be postharvest physiological deterioration. The process of harvesting the agricultural product can include cutting a portion of the agricultural product, thereby exposing a cut surface of the agricultural product. The cut surface of the agricultural product can be contacted with the sulfur-donating compound. In some embodiments, the agricultural product can be a root. In some embodiments, the agricultural product can be a tuberous root. In some embodiments, the agricultural product can be a cassava root.

In some embodiments, contacting the agricultural product with a sulfur-donating compound can include dipping the agricultural product in dry sulfur-donating compound. In some embodiments, contacting the agricultural product with a sulfur-donating compound can include spraying the agricultural product with a solution of the sulfur-donating compound dissolved in a solvent such as water. In some embodiments, contacting the agricultural product with a sulfur-donating compound can include immersing the agricultural product in a solution containing a sulfur-donating compound dissolved in a solvent such as water. The edible composition can be dissolved in a solvent, such as water, at a concentration of between about 400 mg/mL and about 700 mg/mL. In some embodiments, contacting the surface of the agricultural product with a sulfur-donating compound (e.g., salt) can occur before harvest, during harvest, or after harvest.

In some embodiments, sulfur-donating compounds, or compositions containing the same, are applied to the surface, such as a cut surface, of agricultural products to reduce the physiological deterioration of an agricultural product, for example to prevent or reduce the breakdown of endogenous starch in an agricultural product. The breakdown of endogenous starch can be prevented after the agricultural product has been harvested. In some embodiments, the breakdown of endogenous starch can be reduced by at least 5%, 10%, 15%, 20%, 25%, 30%, 35%, 40%, 45%, 50%, 55%, 60%, 65%, 70%, 75%, 80%, 85%, 90%, or 95%.

In other embodiments, sulfur-donating compounds, or compositions containing the same, are applied to the surface, such as a cut surface, of an agricultural product to extend the shelf-life of an agricultural product. In some embodiments, the shelf life of products treated with the sulfur-donating compound or composition containing the same is at least 1 day, 2 days, 3 days, 4 days, 5 days, 6, 7 days, 8 days, 9 days, 10 days, 11 days, 12 days, 13 days, 14 days, or longer.

In some embodiments, the composition reduces the physiological deterioration of the agricultural product. In some embodiments, a method of extending the shelf-life of an agricultural product includes exposing a cut surface of the agricultural product, contacting the cut surface with an edible composition, the edible composition including a sulfur-donating compound, and allowing the sulfur-donating compound to generate a persulfide bond on an endogenous enzyme. In some embodiments, the sulfur-donating compound can generate a persulfide bond on an endogenous enzyme of the agricultural product. In some embodiments, the persulfide can be formed on a cysteine residue of the endogenous enzyme. In some embodiments, the endogenous enzyme can be rhodanese.

In other embodiments, a method of treating an agricultural product includes applying a sulfur-donating compound to a plant of the agricultural product or to the soil in which the agricultural product is grown prior to harvesting of the agricultural product. The method further includes harvesting the agricultural product, thereby separating the agricultural product from the plant and/or removing the agricultural product from the soil. After the harvesting of the agricultural product, a residual amount of the sulfur-donating compound remains on or within the agricultural product.

Contacting the agricultural product with the sulfur-donating compound may reduce the concentration of reactive oxygen species in the agricultural product. The reduction in concentration of reactive oxygen species can cause a reduction in the amount of insoluble oligomers in the agricultural product. The insoluble oligomers may include oligomers of scopoletin.

In some embodiments, the composition is edible. In some embodiments, the composition is an edible composition containing a diluent and a sulfur-donating compound. The diluent can include additional nutrients. The diluent can include at least one of iodine, mannitol, sodium pyruvate, pyruvic acid, thiamine, niacin, folic acid, sodium ascorbate, ascorbic acid, sodium citrate, citric acid, or riboflavin. The diluent can include a carbonate (e.g., sodium carbonate, potassium carbonate), a bicarbonate (e.g., sodium bicarbonate, potassium bicarbonate), sodium nitrite, sodium chloride, potassium chloride, sodium phosphate, potassium phosphate, sodium sulfate, or magnesium sulfate. The diluent can include enzymes that reduce the physiological deterioration of the agricultural product, such as superoxide dismutase, catalase, rhodanese, and/or β-cyanoalanine synthase, or related enzymes. Reducing the physiological deterioration of an agricultural product can comprise preventing the physiological deterioration of the agricultural product. The breakdown of endogenous starch can be prevented after the agricultural product has been harvested.

### BRIEF DESCRIPTION OF THE DRAWINGS

FIG. 1 shows a schematic of the disruption to the mitochondrial transport chain by hydrogen cyanide leading to PPD.

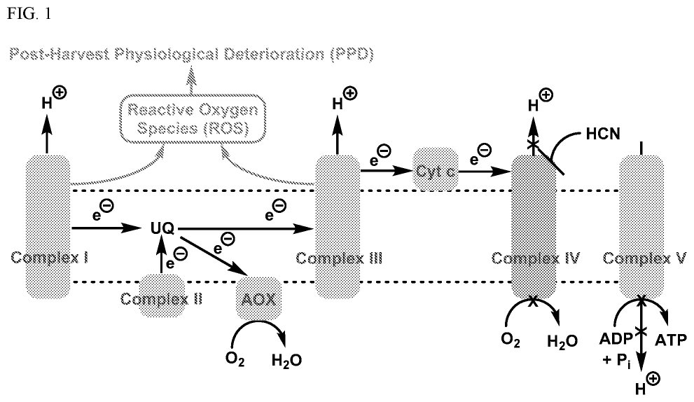

FIG. 2 shows a comparison of treated (right) and untreated (left) cut cassava root sections after 4 days after being treated with sodium thiosulfate powder.

FIG. 3 shows a comparison of treated (right) and untreated (left) cut cassava root sections after 4 days after being treated with a solution containing sodium metabisulfite powder.

FIG. 4 shows a schematic of the effect of HCN on the ability of cassava root to produce ATP.

FIG. 5 shows a plot of the percent of starch loss for treated (solid line) and untreated (dashed line) sections of cassava root as a function of time.

FIG. 6 shows a comparison of the discoloration of powdered cassava root after being treated (right column) and not treated (left column) with sodium thiosulfate.

### DEFINITIONS

As used herein, a “sulfur-donating compound” is any compound capable of forming a persulfide bond or an oxidized version thereof from a thiol group. The compound can be in the form of an uncharged species or a charged species (e.g., salt). The thiol group can be, for instance, cysteine residue of an enzyme (such as rhodanese). The sulfur-donating compound can be a sulfur-donating salt. For instance, the sulfur-donating compound can be a dithionate, dithionite, metabisulfite (i.e. disulfite), tetrathionate, or thiosulfate salt. For example, the sulfur-donating salt can be a salt of dithionate (e.g. lithium dithionate, sodium dithionate, potassium dithionate, cesium dithionate, copper dithionate, silver dithionate, magnesium dithionate, or calcium dithionate). The sulfur-donating salt can be a salt of dithionite (e.g. lithium dithionite, sodium dithionite, potassium dithionite, cesium dithionite, copper dithionite, silver dithionite, magnesium dithionite, or calcium dithionite). The sulfur-donating salt can be a salt of metabisulfite (e.g. lithium metabisulfite, sodium metabisulfite, potassium metabisulfite, cesium metabisulfite, copper metabisulfite, silver metabisulfite, magnesium metabisulfite, or calcium metabisulfite). The sulfur-donating salt can be a salt of tetrathionate (e.g. lithium tetrathionate, sodium tetrathionate, potassium tetrathionate, cesium tetrathionate, copper tetrathionate, silver tetrathionate, magnesium tetrathionate, or calcium tetrathionate). The sulfur-donating salt can be a salt of thiosulfate (e.g. lithium thiosulfate, sodium thiosulfate, potassium thiosulfate, cesium thiosulfate, copper thiosulfate, silver thiosulfate, magnesium thiosulfate, or calcium thiosulfate). The sulfur-donating salt can be any combination of two or more sulfur-donating salts. The sulfur donating salts can be used in anhydrous form. The sulfur donating salts can be used in a hydrated form. In some embodiments, an oxidized persulfide bond can be, e.g., —R—S—S—OH, —R—S—S(O)—OH, —R—S—S(O)₂—OH, wherein R is, for instance, a cysteine residue.

As used herein, “ROS” refers to reactive oxygen species. Reactive oxygen species refer to chemically reactive chemical species containing oxygen. Examples are the superoxide ion ^{⋅}O₂⁻), H₂O₂, ^{⋅}OH, ⁻OH, and ^{⋅}O₂H.

As used herein, the “Electron Transport Chain” refers to the series of complexes that transfer electrons from electron donors to electron acceptors via redox (both reduction and oxidation occurring simultaneously) reactions, and couples this electron transfer with the transfer of protons (H+ ions) across a membrane.

As used herein, the term “PPD” is understood to mean postharvest physiological deterioration. Postharvest physiological deterioration can include spoiling or discoloration of an agricultural food product (e.g., a cassava root). In some cases, PPD includes a discoloration that occurs as a result of the production of scopoletin and related compounds, and from subsequent polymerization reactions. Postharvest physiological deterioration can also include a breakdown of endogenous starch after harvest of the agricultural product.

### DETAILED DESCRIPTION

The present disclosure is directed to the use of one or more exogenous sulfur-donating compounds for the prevention and/or reduction of postharvest physiological deterioration of an agricultural product. In some embodiments, the agricultural product produces an endogenous compound which can degrade, deteriorate, or spoil the agricultural product and which reacts with the sulfur-containing compound resulting in a decrease or reduction in degradation, deterioration, or spoilage. Exemplary endogenous compounds include, but are not limited to, HCN. In some embodiments, the agricultural product can, for example, be a tuberous root such as a cassava root. In the case of treating cassava, the sulfur-donating compound can be applied to a surface of the root, for example a cut surface, and can result in a substantial reduction in PPD and a corresponding increase in the postharvest shelf life of the cassava. The increase in postharvest shelf life can be sufficient to substantially reduce postharvest losses and to enable farmers and processors to be able to import and/or export fresh cassava without sustaining an undue amount of spoilage.

### I. Sulfur-Donating Compounds

The compositions described herein contain one or more sulfur-donating compounds. In some embodiments, the sulfur-donating compound is capable of forming a persulfide bond (or various oxidation states thereof such as oxidized persulfide bonds) from a thiol group. The thiol group can be, for instance, cysteine residue of an enzyme (such as rhodanese). In some embodiments, an oxidized persulfide bond can be, e.g., —R—S—S—OH, —R—S—S(O)—OH, —R—S—S(O)₂—OH, wherein R is, for instance, a cysteine residue.

In other embodiments, the sulfur-donating compound can be a sulfur-donating salt. Suitable sulfur-donating compounds include, but are not limited to, dithionate, dithionite, metabisulfite (i.e. disulfite), tetrathionate, and thiosulfate salt. For example, the sulfur-donating salt can be a salt of dithionate (e.g. lithium dithionate, sodium dithionate, potassium dithionate, cesium dithionate, copper dithionate, silver dithionate, magnesium dithionate, or calcium dithionate). The sulfur-donating salt can be a salt of dithionite (e.g. lithium dithionite, sodium dithionite, potassium dithionite, cesium dithionite, copper dithionite, silver dithionite, magnesium dithionite, or calcium dithionite). The sulfur-donating salt can be a salt of metabi sulfite (e.g. lithium metabi sulfite, sodium metabi sulfite, potassium metabi sulfite, cesium metabisulfite, copper metabisulfite, silver metabisulfite, magnesium metabisulfite, or calcium metabisulfite). The sulfur-donating salt can be a salt of tetrathionate (e.g. lithium tetrathionate, sodium tetrathionate, potassium tetrathionate, cesium tetrathionate, copper tetrathionate, silver tetrathionate, magnesium tetrathionate, or calcium tetrathionate). The sulfur-donating salt can be a salt of thiosulfate (e.g. lithium thiosulfate, sodium thiosulfate, potassium thiosulfate, cesium thiosulfate, copper thiosulfate, silver thiosulfate, magnesium thiosulfate, or calcium thiosulfate). The sulfur-donating salt can be any combination of two or more sulfur-donating salts. The sulfur donating salts can be used in anhydrous form or in a hydrated form.

In some embodiments, treatment of an agricultural product with one or more sulfur-donating compounds can lead to a reduction in the breakdown of endogenous starch during the agricultural product's edible shelf life. In some embodiments, treatment with the sulfur-donating compound reduce the breakdown of endogenous starch by at least 5%, 10%, 15%, 20%, 25%, 30%, 35%, 40%, 45%, 50%, 55%, 60%, 65%, 70%, 75%, 80%, 85%, 90%, or 95%. In other embodiments, the amount of starch that is broken down is less than 70%, 65%, 60%, 55%, 50%, 45%, 40%, 35%, 30%, 25%, 20%, 15%, 10%, or 5%.

### II. Compositions and Formulations

The compounds described herein can be applied in a number of ways to an agricultural product. For example, a cut section of an agricultural product (e.g., cassava root) can be directly dipped into a dry powder containing the sulfur-donating compound. Alternatively, the sulfur-donating compound can be added to or dissolved in a solvent (e.g., water or an alcohol) forming a solution, suspension or colloid. In some embodiments, the alcohol to which the sulfur-donating compound is added includes, but is not limited to, methanol, ethanol, propanol, or isopropanol. In some embodiments, at least a portion (e.g., a cut section) of an agricultural product can be dipped, submerged, or soaked in the solution, suspension, or colloid containing the sulfur-donating compound. In some embodiments, the cut section of the agricultural product can be sprayed with a solution, suspension, or colloid comprising the sulfur-donating compound.

In some embodiments, the compounds described herein, and/or the solutions, suspensions, or colloid containing the sulfur-donating compound, can be applied to the agricultural product (e.g., a cassava plant) prior to harvest, either through direct application (e.g. spray) to the agricultural product, or by applying the compound, solution, suspension, or emulsion to the soil such that it can come in contact with the roots. A residual amount of the sulfur-donating compound can remain on or within the root after harvest, thereby causing a reduction in PPD and corresponding increase in postharvest shelf life.

The sulfur-donating compounds described herein can be dissolved in water and applied to the cut surface of an agricultural product as a solution (e.g., by spraying or immersing in solution). The sulfur-donating compounds can have varying solubility in water. For sulfur-donating salts (e.g., dithionate, dithionite, metabisulfite, tetrathionate, or thiosulfate salts), the concentration of salt can be about 10%, 15%, 20%, 25%, 30%, 35%, 40%, 45%, 50%, 55%, 60%, 65%, 70%, 75%, 80%, 85%, 90%, or 95% of the saturation limit at ambient temperature and pressure (e.g., about 90% of the saturation limit, or the solutions can be saturated). In some embodiments, the concentration can be lower than 80% of the saturation limit at ambient temperature and pressure. In some embodiments, the concentration of the sulfur-donating compound in solution (e.g., water) is from about 10 mg/ml to about 1000 mg/ml, from about 10 mg/mL to about 800 mg/mL, from about 10 mg/mL to about 700 mg/mL, from about 25 mg/mL to about 800 mg/mL, from about 50 mg/mL to about 800 mg/mL, from about 75 mg/mL to about 800 mg/mL, from about 100 mg/mL to about 800 mg/mL, from about 125 mg/mL to about 800 mg/mL, from about 150 mg/mL to about 800 mg/mL, from about 175 mg/mL to about 800 mg/mL, from about 200 mg/mL to about 800 mg/mL, from about 225 mg/mL to about 800 mg/mL, from about 250 mg/mL to about 800 mg/mL, from about 275 mg/mL to about 800 mg/mL, from about 300 mg/mL to about 800 mg/mL, from about 325 mg/mL to about 800 mg/mL, from about 350 mg/mL to about 800 mg/mL, from about 375 mg/mL to about 800 mg/mL, from about 400 mg/mL to about 800 mg/mL, from about 400 mg/mL to about 750 mg/mL, or from about from about 400 mg/mL to about 700 mg/mL.

For example, at standard temperature and pressure, water can become saturated with sodium thiosulfate at a concentration of about 700 mg/mL. Accordingly, in some embodiments, the concentration of a solution (e.g., an aqueous solution) containing sodium thiosulfate can be about 700 mg/mL. In some embodiments, efficacy of sodium thiosulfate-based solutions is found to be highest when aqueous solutions comprising sodium thiosulfate are at a concentration of about 400 mg/mL or higher. Accordingly, in some embodiments, the concentration of the sodium thiosulfate is between about 400 and about 700 mg/mL (e.g., between about 500 and about 700 mg/mL). In some embodiments, the concentration of the sodium thiosulfate salt is about 100, about 200, about 300, about 400, about 500, about 600, or about 700 mg/mL. In some embodiments, the concentration can be lower than 700 mg/mL.

In some embodiments, a metabisulfite solution (e.g., sodium metabisulfite) solution in water can become saturated at about 300 mg/mL. Accordingly, in some embodiments solutions of sodium metabisulfite are used at a concentration of about 300 mg/mL, about 200 mg/mL, or about 100 mg/mL.

### III. Additional Compounds

In addition to the sulfur-donating compounds, the compositions described herein for preventing or reducing spoilage in agricultural products can also contain additional components (e.g., diluents) that can impact/improve the health of those ingesting the compositions. For example, the compositions can contain additional vitamins, minerals, or other essential nutrients. In some embodiments, the additional nutrients do not significantly contribute to the scavenging of endogenous molecules, such as HCN, but can nevertheless be added to supplement the diet of the person or animal eating the agricultural product. For example, the edible compositions herein can include a sugar alcohol such as mannitol. In some embodiments, the edible composition herein can include a pyruvate species such as pyruvic acid or sodium pyruvate. In some embodiments, the edible compositions herein can include vitamin A. In some embodiments, the edible compositions herein can include any of the B vitamins (e.g., vitamin B1, B2, B3, B5, B6, B7, B9 or B12). In some embodiments, the edible compositions herein can include vitamin C. In some embodiments, the edible compositions herein can include any of the D vitamins (e.g., vitamin D1, D2, D3, D4, or D5). In some embodiments, the edible compositions herein can include vitamin E. In some embodiments, the edible compositions disclosed herein can include citric acid or salts of citric acid (e.g mono, di, and tricitrates of lithium, sodium, potassium, cesium, copper, silver, magnesium, calcium). In some embodiments, the edible compositions herein can include other essential nutrients such as iodine (e.g., iodide).

In some embodiments, the edible compositions can further include a nitrite salt (e.g. lithium nitrite, sodium nitrite, potassium nitrite, magnesium nitrite, or calcium nitrite). The nitrite species can, for example, serve as an additional scavenger for cyanide ions. In some embodiments, the weight of the nitrite species within the composition is about 10%, about 20%, about 30%, about 40%, about 50%, less than about 10%, less than about 20%, less than about 30%, less than about 40%, less than about 50%, less than about 60%, between about 1% and about 10%, between about 1% and about 20%, between about 1% and about 30%, between about 1% and about 40%, between about 1% and about 50%, or between about 1% and about 60% of the weight of the sulfur-donating compound within the composition.

The additional components (e.g., diluents such as vitamins) can be present in the compositions herein at a concentration less than the relative concentration of the sulfur-donating compound. For example, the diluent can be present at a concentration (by mass) of about 1% of the sulfur-donating compound, about 2% of the sulfur-donating compound, about 3% of the sulfur-donating compound, about 4% of the sulfur-donating compound, about 5% of the sulfur-donating compound, less than about 5% of the sulfur-donating compound, less than about 10% of the sulfur-donating compound, less than about 20% of the sulfur-donating compound, less than about 50% of the sulfur-donating compound, between about 0.5% and about 5% of the sulfur-donating compound, between about 0.5% and about 10% of the sulfur-donating compound, between about 0.5% and about 20% of the sulfur-donating compound, or between about 0.5% and about 50% of the sulfur-donating compound.

Furthermore, in some embodiments sulfur-donating compounds can be shelf stable (e.g., can be stored indefinitely without deteriorating). In some embodiments, the edible compositions described herein can include other components such as preservatives, desiccants, pH modifiers, and/or stabilizers. For example, in some embodiments, the edible compositions herein can further include salts of carbonate (e.g., lithium carbonate, sodium carbonate, potassium carbonate, cesium carbonate, copper carbonate, silver carbonate, magnesium carbonate, and/or calcium carbonate) or salts of bicarbonate (e.g. lithium bicarbonate, sodium bicarbonate, potassium bicarbonate, cesium bicarbonate, copper bicarbonate, silver bicarbonate, magnesium bicarbonate, and/or calcium bicarbonate. In some embodiments, the carbonate or bicarbonate can comprise about 1%, about 2%, about 3%, about 4%, about 5%, about 6%, about 7%, about 8%, about 9%, about 10%, less than about 5%, less than about 10%, less than about 20%, less than about 50%, between about 1% and about 5%, between about 1% and about 10%, between about 1% and about 20%, between about 1% and about 30%, between about 1% and about 40%, or between about 1% and about 50% of the weight percent of the sulfur-donating compound within the composition.

In some embodiments, the edible compositions can further contain an additional salt (e.g. as a diluent). For example, the compositions can comprise a salt such as chloride salts (e.g. lithium chloride, sodium chloride, potassium chloride, cesium chloride, magnesium chloride, calcium chloride), such as phosphate salts (e.g. lithium phosphate, sodium phosphate, potassium phosphate, cesium phosphate, calcium phosphate, magnesium phosphate, lithium diphosphate, sodium diphosphate, potassium diphosphate, cesium diphosphate, calcium diphosphate, magnesium diphosphate, dilithium hydrogen phosphate, disodium hydrogen phosphate, dipotassium hydrogen phosphate, lithium dihydrogen phosphate, sodium dihydrogen phosphate, potassium dihydrogen phosphate), such as sulfate salts (lithium sulfate, sodium sulfate, potassium sulfate, magnesium sulfate, calcium sulfate, lithium hydrogen sulfate, sodium hydrogen sulfate, potassium hydrogen sulfate, magnesium hydrogen sulfate, calcium hydrogen sulfate) and/or sulfite salts (lithium sulfite, sodium sulfite, potassium sulfite, lithium hydrogen sulfite, sodium hydrogen sulfite, potassium hydrogen sulfite). In some embodiments, the salt can comprise about 1%, about 2%, about 3%, about 4%, about 5%, less than about 5%, less than about 10%, less than about 20%, less than about 50%, between about 1% and about 5%, between about 1% and about 10%, between about 1% and about 20%, between about 1% and about 30%, between about 1% and about 40%, or between about 1% and about 50% of the weight percent of the sulfur-donating compound within the composition.

In some embodiments, the edible composition can further contain an additional enzyme or combination of enzymes, which may reduce physiological deterioration by scavenging key contributors to PPD. For example, this can be an enzyme that aids in scavenging reactive oxygen (e.g. catalase, superoxide dismutase, or combinations thereof). In some embodiments, this enzyme aids in the scavenging of hydrogen cyanide, or salts thereof (e.g. rhodanese, β-cyanoalanine synthase, or a combination thereof). In some embodiments, the mass of the enzyme or enzymes within the composition can be about 0.1% or less, about 0.2% or less, about 0.3% or less, about 0.4% or less, about 0.5% or less, about 0.6% or less, about 0.7% or less, about 0.8% or less, about 0.9% or less, about 1% or less, between about 0.05% and about 0.1%, between about 0.05% and about 0.2%, between about 0.05% and about 0.3%, between about 0.05% and about 0.4%, between about 0.05% and about 0.5%, between about 0.05% and about 0.6%, between about 0.05% and about 0.7%, between about 0.05% and about 0.8%, between about 0.05% and about 0.9%, or between about 0.05% and about 1% of the mass of the sulfur-donating compounds within the composition.

### III. Methods of Using of Sulfur-Donating Compounds

As described above, the sulfur-donating compounds and compositions containing the same can be used to treat agricultural products that (1) produce one or more endogenous compounds that cause degradation, deterioration, and/or spoilage of the agricultural product and/or (2) produce reactive oxygen species. Exemplary agricultural products that produce such endogenous compounds include, but are not limited to, apples, avocados, potatoes, mangoes, pears, grapes, and root vegetables, such as cassava root.

A. Cassava

In order to combat the cytotoxicity of hydrogen cyanide, the cassava plant can produce detoxifying enzymes (e.g. rhodanese), which can convert hydrogen cyanide, or salts thereof, into thiocyanic acid (HSCN), or salts thereof, which can be a less toxic compound to the plant. It has been found that the detoxification mechanism of rhodanese can rely on the availability of sulfur-donating compounds, which the enzyme can utilize to form a persulfide (or various oxidation states thereof) on a cysteine residue in the active site of the enzyme (e.g., Cys 247 of rhodanese) as set forth below in Scheme 2.

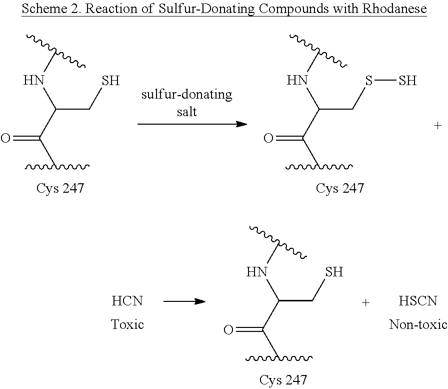 [SMILES: *NC(CS)C(*)=O ; *NC(CSS)C(*)=O ; "HCN" ; *NC(CS)C(*)=O ; "HSCN"]

Again referring to Scheme 2, this persulfide can react directly with cyanide to form comparatively non-toxic thiocyanic acid (HSCN), or various salts and oxidation states thereof, thus detoxifying the cyanide. However, in the absence of a sulfur-donating compound, no substantial detoxification occurs, which can leave the root vulnerable to PPD. In some embodiments, rhodanese is an enzyme responsible for detoxifying cyanide from the cassava plant. In some embodiments the hydrogen cyanide, or salts thereof, can react directly with the sulfur donating salt to form non-toxic thiocyanic acid, or various salts and oxidation states thereof.

### Reduction of Physiological Deterioration

A visible indicator of PPD in cassava is the appearance of discoloration in the root. The discoloration can be triggered by the production of reactive oxygen species from the mitochondria, which can cause the cell to experience an increase in phenylpropanoid metabolism, which in turn can increase the concentration of phenolic compounds such as scopoletin, as shown below in Scheme 3. Reactive oxygen species in the root can convert ferulic acid into scopoletin (or related compounds), which in turn can react further (e.g. oligomerize), again in the presence of further reactive oxygen species, and in some cases, in the presence of additional enzymes (e.g. polyphenol oxidases) in the root.

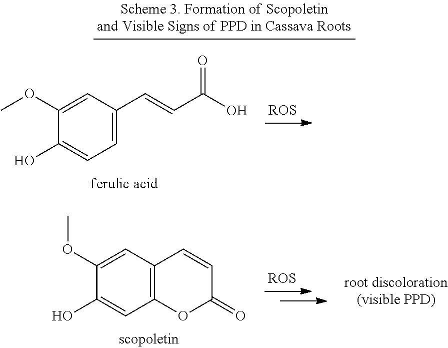

Upon further reaction (e.g. oligomerization), scopoletin and related coumarins can precipitate as dark colored spots and streaks in the root. Because the discoloration can be correlated to the production of off-flavors in the cassava and discoloration of the starch, the visual appearance (i.e., discoloration) of the cassava can negatively influence acceptance by consumers and processors.

Accordingly, as described herein, PPD can be suppressed or prevented by addressing the cyanide levels in native agricultural product varieties such as cassava by employing a pre-harvest or post-harvest treatment of the agricultural product with a sulfur-donating compound. Without wishing to be bound by theory, the addition of the sulfur-donating compound can enable rhodanese to effectively scavenge HCN, or salts thereof, that are produced upon harvest of the agricultural product such as cassava root. As the concentration of HCN, or salts thereof, is reduced before it can inhibit Complex IV, the electron transport chain can function normally. For example, the absence of cyanide can prevent the upstream buildup of reactive oxygen species (e.g., from Complex I and/or Complex III), and it can also enable Complex V to produce ATP as normal.

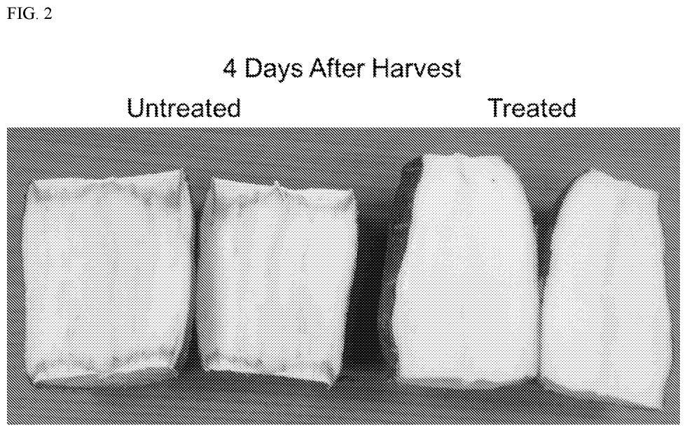

Examples 1 and 2 below demonstrate the effectiveness of methods and formulations described herein for reducing spoilage in cassava roots. As set forth in Example 1, a cut section of a cassava root was treated by dipping the cut section of the root into a dry powder composed of sodium thiosulfate. As shown in FIG. 2, after four days, the untreated sections of the cassava were characterized by discoloration (left two sections). Without wishing to be bound by theory, these streaks were believed to be the result of the production of hydroxycoumarins caused by the presence of reactive oxygen species, which can be the result of increased endogenous HCN. However, after four days, the treated sections of the cassava root were largely free of such discoloration.

In some embodiments, the treated cassava sections can still be edible days after being cut. For example, the treated cassava sections can still be edible at least 1 day, at least 2 days, at least 3 days, at least 4 days, at least 5 days, at least 6 days, at least 7, at least 8, at least 9, at least 10, at least 11, at least 12, at least 13, or at least 14 days after being cut. In contrast, similar sections of untreated cassava roots (i.e., adjacent sections from the same root that were not treated) were inedible after a much shorter amount of time. Typically, treated sections had an edible shelf life that was at least 1 day, 2 days, 3 days, 4 days, 5 days, 6, 7 days, 8 days, 9 days, or 10 days longer than untreated cassava. Accordingly, the methods and formulations described herein can be effective at preventing, reducing, or eliminating the formation of discoloration in agricultural products (e.g., tuberous roots such as cassava). For instance, in some embodiments, the methods and compositions described herein are effective at preventing the formation of discoloration within 1 day, 2 days, 3 days, 4 days, 5 days, 6 days, 7 days, 8 days, 9 days, 10 days, 11 days, 12 days, 13 days, or 14 days of the agricultural product (e.g., tuberous root such as cassava) being cut.

### Prevention of Starch Breakdown

A major driver of economic losses due to PPD in agricultural products such as cassava can be due to the concomitant breakdown of starch in the root. For instance, breakdown of starch can limit the use of cassava by processors. Starch breakdown can be a side effect of the inhibition of ATP production in the mitochondrial electron transport chain by hydrogen cyanide, or salts thereof. In other words, as ATP levels drop (e.g., due to upstream inhibition of Complex IV), the cell can metabolize starch into monosaccharides (e.g., glucose) in an effort to increase ATP production. This can mean that the irreversible inhibition of Complex IV by cyanide can effectively turn the starch metabolism on permanently.

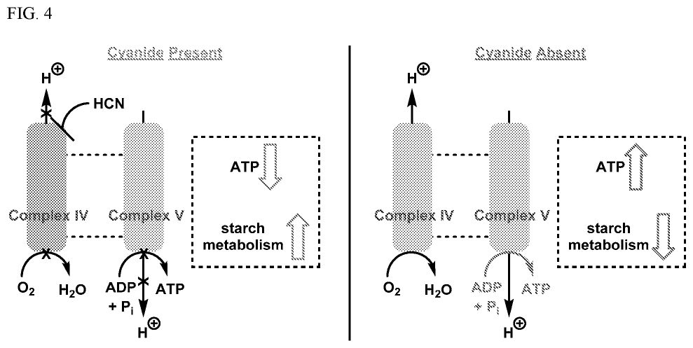

FIG. 4 shows a proposed schematic for the impact of HCN, or salts thereof, on the ability of some agricultural products such as cassava root to produce ATP. Without wishing to be bound by theory, it is believed that as HCN, or salts thereof, inhibits Complex IV (e.g., in the absence of an effective treatment), the ability of Complex V to produce ATP is reduced. This causes the root to begin metabolizing starch in order to produce more ATP, as shown in the left-hand side of FIG. 4. In contrast, as shown in the right-hand side of FIG. 4, when Complex IV is able to function properly (e.g., when it is not inhibited by HCN, or salts thereof), Complex V is able to produce ATP, thereby reducing the root's need to metabolize starch.

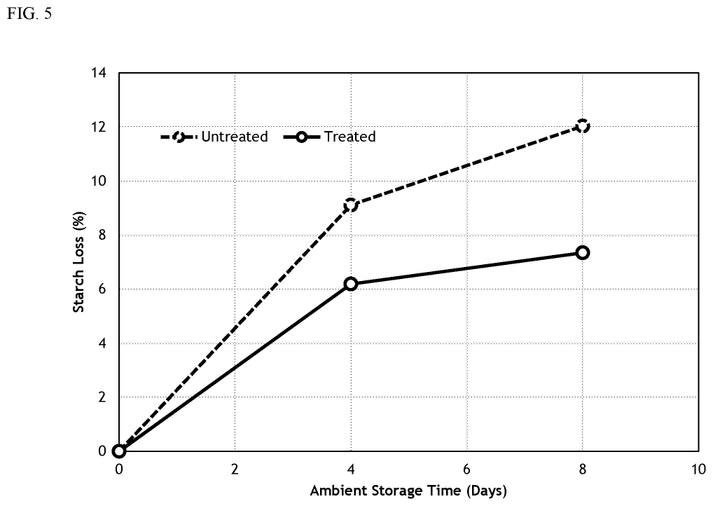

As described in Example 3 below, postharvest treatment of cassava roots with a sulfur-donating compound led to a reduction in the amount of starch lost over time. For example, FIG. 5 shows that untreated cassava roots lost about 9% of their total starch after 4 days, and about 12% of their total starch 8 days after the harvest. In contrast, cassava roots that were treated with sodium thiosulfate had only lost about 6% of their starch after 4 days and less than 8% of their starch after 8 days postharvest. As shown in FIG. 5, the percentage of starch lost after 8 days in a treated cassava root was roughly the same as the amount of starch lost after just 3 days in an untreated cassava root. Without wishing to be bound by theory, this suggests that reduction of HCN, or salts thereof, not only reduce PPD, but also correlate to reduced starch loss. Additionally, because of the prevention of discoloration in the root resulting from application of a sulfur-donating compound, the starch from the cassava root that was treated (right column) with a sulfur-donating compound was largely free of discoloration, whereas untreated starch from the cassava root was discolored after 8 and even after 4 days.

### EXAMPLES

The disclosure is further illustrated by the following examples, which are not to be construed as limiting this disclosure in scope or spirit to the specific procedures herein described. It is to be understood that the examples are provided to illustrate certain embodiments and that no limitation to the scope of the disclosure is intended thereby. It is to be further understood that resort may be had to various other embodiments, modifications, and equivalents thereof which may suggest themselves to those skilled in the art without departing from the spirit of the present disclosure and/or scope of the appended claims.

### General Methods

All reagents and solvents were purchased and used without further purification unless specified. Cassava was harvested according to standard farming practices from the International Center for Tropical Agriculture (CIAT) in Palmira, Colombia, from the International Institute of Tropical Agriculture in Ibadan, OYO State, Nigeria, and from Niji Farm in Ilero, Oyo State, Nigeria. After harvest, the cassava was placed in bags that were vacuum sealed for transport, or treated onsite within 48 hours after harvest. All cassava was kept in the vacuum sealed bags until required for experimentation, usually within a week of receipt of the cassava roots. After removing the cassava roots from the vacuum sealed bags, the cassava was checked for signs of postharvest physiological deterioration, and the roots were used for experiments immediately.

### Example 1 Postharvest Physiological Deterioration Study in Cassava Roots: Treatment with Thiosulfate Powder

Cassava roots were divided into 3-inch segments, ensuring that each segment had a fresh cut at each side. After determining that there was no PPD in the root segments, the cut surfaces of the cassava were dipped into sodium thiosulfate pentahydrate powder (>99.5% purity), ensuring that the whole of the cut surface was covered. From each root, an untreated segment was set aside for comparison. At periodic intervals, the cassava segments were sliced longitudinally and analyzed for signs of PPD. Each treated segment was referenced to an untreated control.

FIG. 2 shows a comparison of an untreated cassava root (left two segments) with treated cassava root (right two segments) after four days. As shown in FIG. 2, the left-two segments show discoloration, whereas the right-two segments show considerably less discoloration. Without wishing to be bound by any theory, the discoloration is the result of the production of scopoletin from ferulic acid in the presence of reactive oxygen species and subsequent oligomerization.

### Example 2 Postharvest Physiological Deterioration Study in Cassava Roots: Treatment with Metabisulfate Solution

Cassava roots were divided into 6-inch segments, ensuring that each segment had a fresh cut at each side. After determining that there was no PPD in the root segments, the cut surfaces of the cassava were dipped into a solution comprising sodium metabisulfite powder (>99.0% purity) in water at a concentration of 300 mg/mL, ensuring the cut surface was fully contacted with the solution. From each root, an untreated segment was set aside for comparison. At periodic intervals, the cassava segments were sliced longitudinally and analyzed for signs of PPD. Each treated segment was referenced to an untreated control.

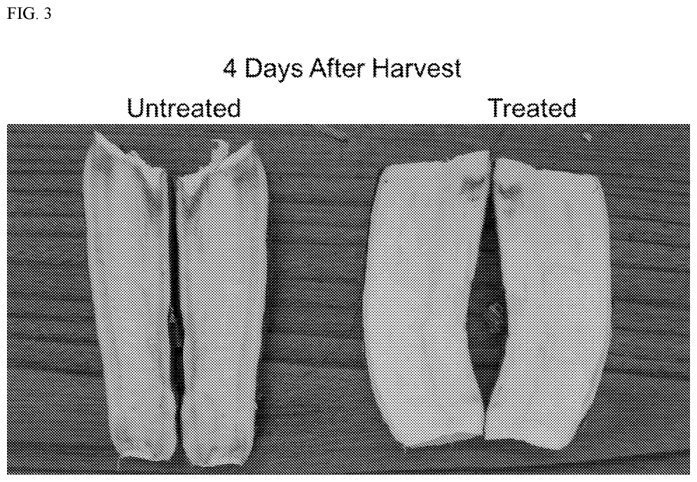

FIG. 3 shows a comparison of an untreated cassava root (left two segments) with treated cassava root (right two segments) after four days. As shown in FIG. 3, the left-two segments show discoloration, whereas the right-two segments show considerably less discoloration. Without wishing to be bound by any theory, the discoloration is believed to be the result of the production of scopoletin and subsequent oligomerization.

### Example 3 Evaluation of Starch Breakdown in Postharvest Cassava Roots

Cassava roots were divided into 3-inch segments, ensuring that each segment had a fresh cut at each side. After determining that there was no PPD in the root segments, the cut surfaces of the cassava were dipped into sodium thiosulfate pentahydrate powder (>99.5% purity), ensuring that the whole of the cut surface was covered. From each root, an untreated segment was set aside for comparison for eight days.

At 4-day intervals (two intervals total), cassava segments were cut into <1 cm thick slices and the cortex was removed from the segments. The slices were dehydrated for 24 hours using a food dehydrator set to 130° F. After dehydration, the desiccated cassava slices were ground with a mortar and pestle. The cassava powder was further dried in a vacuum oven to ensure complete dehydration, and the mass was recorded (i.e., the initial mass of cassava flour). A known amount of cassava powder was placed in a blender, and deionized water was added at a ratio of 1 g of cassava powder to 2.5 mL of water. The mixture was then blended in a slurry. The slurry was filtered over a sieve (100 mesh) into a centrifuge vial to remove the fibrous chaff. The filtrate (i.e., chaff) was rinsed with one volume equivalent of deionized water and pressed dry with a rubber spatula. The liquid in the centrifuge vial was diluted until the centrifuge vial was 80% full, and then centrifuged at 8500 RPM for 10 minutes to pelletize the starch. The supernatant (i.e. the solution containing any soluble sugars) was decanted and the pellet (i.e. the insoluble portion containing any starch) was placed in a vacuum oven until fully dry. The mass of the isolated starch was recorded. The isolated starch (i.e. the dried pellet) was compared to the initial mass of the cassava powder (i.e. the powder containing the fibrous chaff, the soluble sugars, and the insoluble starch) to determine the percentage of the cassava powder that was starch.

Referenced to an untreated control, the addition of sodium thiosulfate pentahydrate to the cut surface of the cassava root reduced the rate of starch metabolism. At day 4 of the study, the treated cassava root had lost 6% of its total starch and the untreated cassava root had lost 9% of its total starch. At day 8 of the study, the treated cassava root had lost less than 8% of its total starch, and the untreated cassava root had lost 12% of its total starch. This was equal to the starch level observed at day 3 of the untreated control sample. The results of the starch reduction assay are shown graphically in FIG. 5. As set forth in FIG. 5, each data point represents an average starch loss percentage for 10 cassava segments.

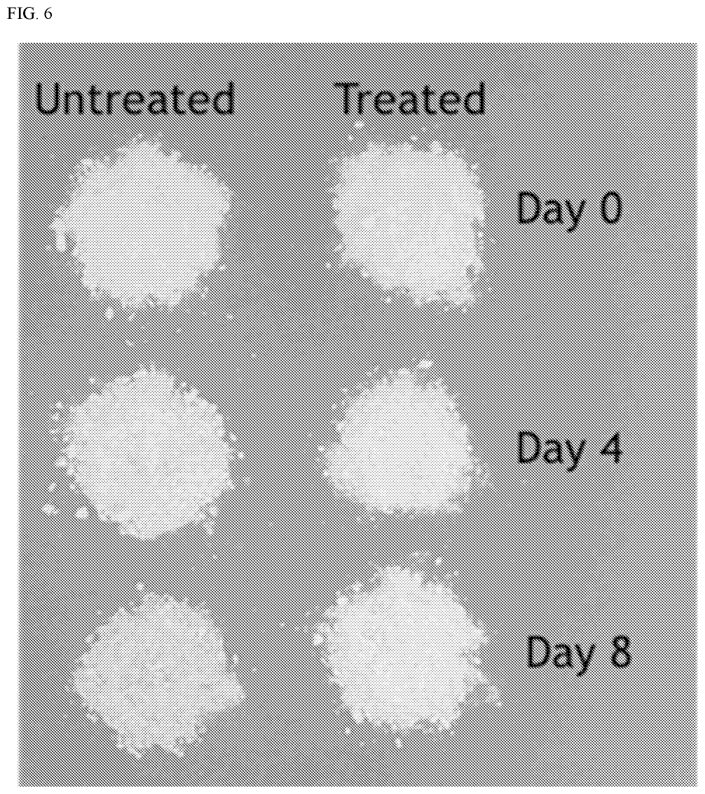

In addition to improved starch retention, sodium thiosulfate treatment also yielded starch with significantly reduced discoloration, as shown in FIG. 6. The left column of untreated starch samples shows progressive brown discoloration, whereas the right column of treated samples shows reduced discoloration.

### EQUIVALENTS

Various implementations of the compositions and methods have been described above. However, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modification are in accordance with the variations of the disclosure. The implementations have been particularly shown and described, but it will be understood that various changes in form and details may be made. Accordingly, other implementations are within the scope of the following claims.

1.-116. (canceled)

117. A method for reducing physiological deterioration of an agricultural product, the method comprising:
cutting a portion of the agricultural product to expose a cut surface of the agricultural product; and
treating the cut surface of the agricultural product with a sulfur-donating compound to reduce a concentration of reactive oxygen species in the agricultural product.

118. The method of claim 117, wherein reducing the concentration of reactive oxygen species in the agricultural product comprises reducing an amount of insoluble oligomers in the agricultural product.

119. The method of claim 118, wherein the agricultural product is a root.

120. The method of claim 118, wherein treating the cut surface with a sulfur-donating compound generates a persulfide bond with an endogenous enzyme of the agricultural product changing an oxidation state of at least one of the endogenous enzyme or a cofactor.

121. The method of claim 118, wherein the sulfur-donating compound is selected from the group consisting of dithionate salts, dithionite salts, metabisulfite salts, tetrathionate salts, thiosulfate salts, and combinations thereof.

122. The method of claim 118, wherein treating the cut surface of the agricultural product with a sulfur-donating compound comprises dipping at least a portion of the cut surface into a dry sulfur-donating compound.

123. The method of claim 118, further comprising dissolving the sulfur-donating compound in a solvent to form a sulfur-donating solution thereof.

124. The method of claim 123, wherein treating the cut surface of the agricultural product comprises at least one of spraying the sulfur-donating solution onto at least a portion of the cut surface and immersing at least a portion of the cut surface into the sulfur-donating solution.

125. The method of claim 123, wherein the sulfur donating compound is dissolved in a concentration of between about 400 mg/ml and about 700 mg/ml of solvent.

126. The method of claim 118, further comprising diluting the sulfur-donating compound with a diluent.

127. The method of claim 126, wherein the diluent comprises at least one of iodine, mannitol, sodium pyruvate, pyruvic acid, thiamine, niacin, folic acid, sodium ascorbate, ascorbic acid, sodium citrate, citric acid, riboflavin, and combinations thereof.

128. The method of claim 126, wherein the diluent comprises at least one of sodium carbonate, potassium carbonate, sodium bicarbonate, potassium bicarbonate, sodium nitrite, sodium chloride, potassium chloride, sodium phosphate, potassium phosphate, sodium sulfate, magnesium sulfate, and combinations thereof.

129. The method of claim 126, wherein the diluent comprises enzymes selected from the group consisting of superoxide, dismutase, catalase, rhodanese, β-cyanoalanine synthase, and combinations thereof.

130. An edible sulfur-donating composition for application to a surface of an agricultural product, comprising:
a sulfur-donating compound; and
a diluent for dissolving the sulfur-donating compound therein forming the edible sulfur-donating composition;
wherein the edible sulfur-containing composition, when applied to the agricultural product, reduces a concentration of reactive oxygen species in the agricultural product.

131. The edible sulfur-donating composition of claim 130, wherein when applied to the agricultural product reduces an amount of insoluble oligomers in the agricultural product.

132. The edible sulfur-donating composition of claim 131, wherein the sulfur-donating compound is selected from the group consisting of dithionate salts, dithionite salts, metabisulfite salts, tetrathionate salts, thiosulfate salts, and combinations thereof.

133. The edible sulfur-donating composition of claim 131, wherein the diluent comprises at least one of iodine, mannitol, sodium pyruvate, pyruvic acid, thiamine, niacin, folic acid, sodium ascorbate, ascorbic acid, sodium citrate, citric acid, riboflavin, and combinations thereof.

134. The edible sulfur-donating composition of claim 131, wherein the diluent comprises at least one of sodium carbonate, potassium carbonate, sodium bicarbonate, potassium bicarbonate, sodium nitrite, sodium chloride, potassium chloride, sodium phosphate, potassium phosphate, sodium sulfate, magnesium sulfate, and combinations thereof.

135. The edible sulfur-donating composition of claim 131, wherein the diluent comprises enzymes selected from the group consisting of superoxide, dismutase, catalase, rhodanese, β-cyanoalanine synthase, and combinations thereof.

136. A method for extending the shelf-life of an agricultural product, the method comprising:
cutting a portion of the agricultural product to expose a cut surface of the agricultural product; and
treating the cut surface of the agricultural product with a sulfur-donating compound to reduce a concentration of reactive oxygen species in the agricultural product.

137. The method of claim 136, wherein treating the cut surface with a sulfur-donating compound generates a persulfide bond with an endogenous enzyme of the agricultural product changing an oxidation state of at least one of the endogenous enzyme or a cofactor.

138. The method of claim 136, wherein the sulfur-donating compound is selected from the group consisting of dithionate salts, dithionite salts, metabisulfite salts, tetrathionate salts, thiosulfate salts, and combinations thereof.
